(19) United States
(12) Patent Application Publication
(10) Pub. No.: US 2009/0104370 A1
(43) Pub. Date: Apr. 23, 2009

(54) MICRO-STRUCTURAL FILM MANUFACTURING PROCESS

(75) Inventors: CHI-FENG LIN, TAINAN HSIEN (TW); PO-HUA YANG, TAINAN HSIEN (TW)

Correspondence Address: ROSENBERG, KLEIN & LEE, 3458 ELLICOTT CENTER DRIVE-SUITE 101, ELLICOTT CITY, MD, 21043, US

(73) Assignee: NATIONAL APPLIED RESEARCH LABORATORIES, NATIONAL CENTER FOR HIGH-PERFORMANCE, HSINCHU (TW)

(21) Appl. No.: 11/873,749

(22) Filed: Oct. 17, 2007

(51) Int. Cl. B05D 3/06; B05D 1/36

(52) U.S. Cl. 427/510; 427/202

(57) ABSTRACT

A micro-structural film manufacturing process operating on a principle of static absorption by having multiple optical particles adhered to an adhesive layer containing adhesion on a surface of a base material, followed with solidification and static removing processes for the optical particles to form a film of micro-lens diffusion layer to deliver scattering results when light is permeated for achieving the purpose of having uniform luminance while reducing production cost and allowing control the surface of the base material to develop a micro-structural film under different diffusion conditions.

### BACKGROUND OF THE INVENTION

(a) Field of the Invention

The present invention relates to a micro-structural film manufacturing process, and more particularly, to one that operates on static absorption principle to adhere optical particles to an adhesion layer on a surface of a base material provided with adhesive, followed with solidification and static removing processes to develop optical particles into micro-lens diffuser film.

(b) Description of the Prior Art

In a micro-structural film process of the prior art as illustrated in FIG. 11 of the accompanying drawings, a diffuser structure coated with particles and binders. A surface of a base material (A) is coated with a diffusion layer (B) containing optical particles (B1), another type of optical particles (B2) and a binder (B3); however this process fails to control ratios of composition particles depending on a region coated, i.e., it fails to cope with practical need to adjust ratio of distribution and location of particles as desired.

Another prior art as illustrated in FIG. 12 involves a surface structure of diffusion film pressed using a mold, wherein a hemispheric mold provided with indentions to achieve by pressing multiple raised hemispheric round points (C). The hemispherical round point (C) also provides the similar functions as a diffusion layer (B) as produced from using the previous process of the prior art; however, in this process, mold must be first developed to result in higher production cost.

Both processes of the prior art as described though are sufficient to achieve the basic function of a diffusion layer, ratio of distribution and location of particles and cost of production are subject to great limitations in filed production.

Those flaws found with the prior art warrant feasible improvement in meeting advancing the manufacturing industry of micro-structural film process to offer more technical options for the industry.

### SUMMARY OF THE INVENTION

The primary purpose of the present invention is to provide a solution to those problems of failure in controlling distribution ratio and location of particles and higher piloting process cost suffered by the prior art.

To achieve the purpose, a micro-structural film manufacturing process of the present invention is essentially comprised of the following steps in sequence:

A. coating: an adhesion layer containing adhesive is coated on a surface of a base material;

B. charging: at specific locations of a roller is controlled to indicate a status of carrying negative charges by means of laser or other device;

C. absorption: multiple optical particles carrying positive charges are absorbed to the roller;

D. adhesion: the optical particles carrying positive charges absorbed to the roller are adhered to the adhesion layer on the surface of the base material;

E. solidification: a binder and a solidifier of a solidification device is used to solidify the optical particles adhered to the base material; and

F. removing static: static carried by the roller and by the base material adhered with the optical particles are removed using a static remover.

In the process, the roller maintains its rolling status while the base material is in a straight advancing status with the base material maintaining a tangent relation with an outer circumference of the roller and a given gap being maintained between the roller and base material to engage in relative movement.

The optical particles are made of transparent or translucent material in any shape, or size as desired.

The solidification step involves use of binding resin in conjunction with a heater or use of ultraviolet (UV) hardened resin in conjunction with an ultraviolet (UV) lamp.

The present invention by using the roller to produce distribution of static regions and using the optical particles in different sizes and shapes for the base material to develop a micro-structural film under different diffusion conditions provides the following advantages:

1. The present invention provides a micro-structural film manufacturing process that is capable of reducing production cost and controlling the surface of the base material to develop a micro-structural film under different diffusion conditions;

2. The present invention is capable of manufacturing a diffuser allowing control of various densities of particles depending on the region involved without needing a mold; and

3. The present invention by using a roller to produce different regions of static and different adhesion particles is capable of controlling size, shape, distribution density, and location of particles for achieving the purpose of controlling the diffusion to yield better uniform luminance.

### BRIEF DESCRIPTION OF THE DRAWINGS

FIG. 1 is a flow path chart of a micro-structural film manufacturing process of a preferred embodiment of the present invention.

FIG. 2 is a first schematic view of the micro-structural film manufacturing process of the preferred embodiment of the present invention.

FIG. 3 is a second schematic view of the micro-structural film manufacturing process of the preferred embodiment of the present invention.

FIG. 4 is a third schematic view of the micro-structural film manufacturing process of the preferred embodiment of the present invention.

FIG. 5 is a fourth schematic view of the micro-structural film manufacturing process of the preferred embodiment of the present invention.

FIG. 6 is a schematic view showing a gap defined between a base material and a roller in the preferred embodiment of the present invention.

FIG. 7 is a schematic view showing an operating status of a rotary storage tank for optical particles in the preferred embodiment of the present invention.

FIG. 8 is a schematic view showing a collective type of micro-structural diffusion film in the preferred embodiment of the present invention.

FIG. 9 is a schematic view showing a dispersion type of micro-structural diffusion film in the preferred embodiment of the present invention.

FIG. 10 is a schematic view showing a mixed type of micro-structural diffusion film in the preferred embodiment of the present invention.

FIG. 11 is a schematic view showing a construction of a diffusion layer of the prior art coated with particles and adhesive.

FIG. 12 is a photo showing surface structure of a diffusion film pressed using a mold of the prior art.

### DETAILED DESCRIPTION OF THE PREFERRED EMBODIMENTS

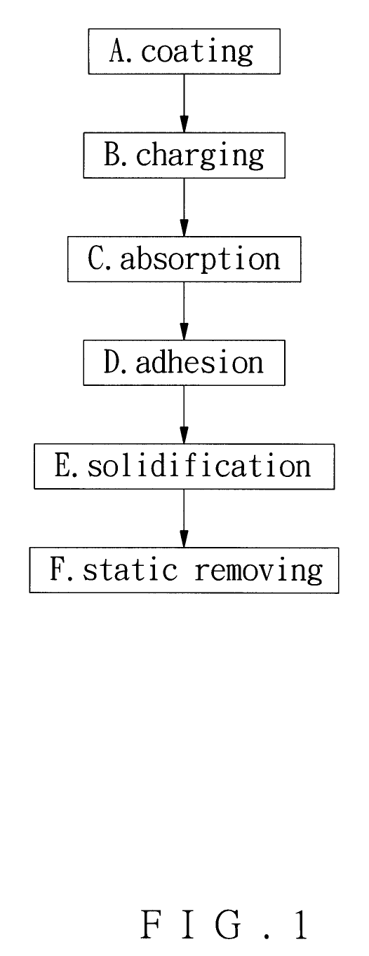

Referring to FIG. 1 for a flow path chart of a micro-structural film manufacturing process of a preferred embodiment of the present invention, the manufacturing process of the micro-structural film is comprised of the following steps in sequence:

A. coating: an adhesion layer containing adhesive is coated on a surface of a base material;

B. charging: at specific locations of a roller is controlled to indicate a status of carrying negative charges by means of laser or other device;

C. absorption: multiple optical particles carrying positive charges are absorbed to the roller;

D. adhesion: the optical particles carrying positive charges absorbed to the roller are adhered to the adhesion layer on the surface of the base material;

E. solidification: a binder and a solidifier of a solidification device is used to solidify the optical particles adhered to the base material; and

F. removing static: static carried by the roller and by the base material adhered with the optical particles are removed using a static remover.

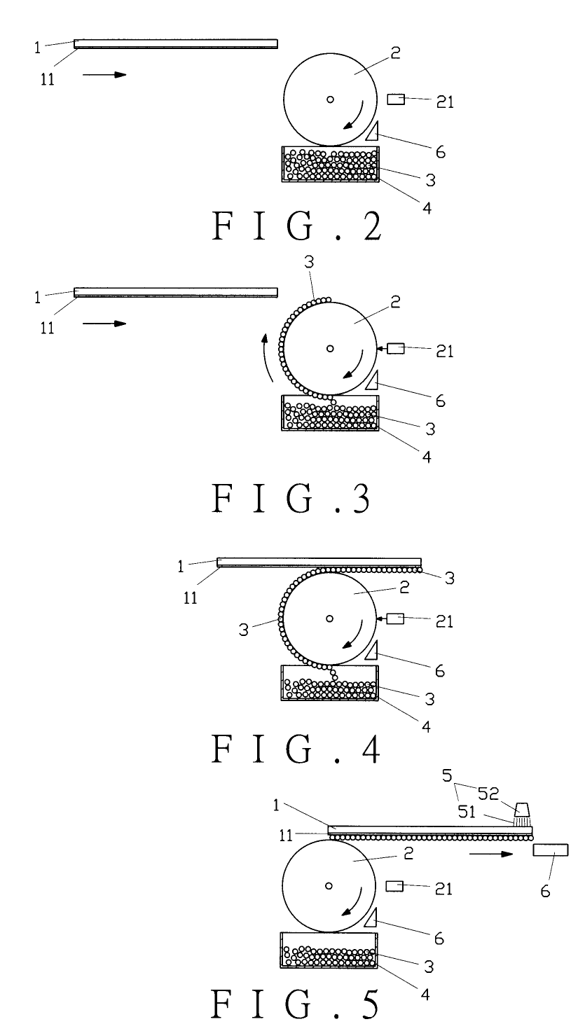

Now referring to FIGS. 2 through 5, a preferred embodiment of the present invention includes a base material (1), a roller (2), multiple optical particles (3), a storage unit (4), a solidification device (5), and a static remover (6).

As illustrated in FIG. 2 showing a schematic view of a preferred embodiment of a manufacturing process of micro-structural film, an adhesion layer (11) containing adhesion is coated on a surface of the base material (1) and the roller (2) maintains its neutral status while the optical particles (3) carrying positive charges are stored in the storage unit (4). As type of motion is concerned, the roller (2) is in its rotation status and the base material (1) is in its straight advancing status.

In a second schematic view showing the preferred embodiment of the manufacturing process of micro-structural film as illustrated in FIG. 3, at given locations on the roller (2) is controlled to becoming a status of carry negative charges by using a charging device (21) of laser or other device while the optical particles (3) carrying positive charges are absorbed to the roller (2).

In a third schematic view showing the preferred embodiment of the manufacturing process of micro-structural film as illustrated in FIG. 4, the optical particles (3) carrying positive charges are absorbed to the roller (2) and adhered to the adhesion layer (11) on the surface of the base material (1).

As illustrated in FIG. 5 for a fourth schematic view showing the preferred embodiment of the manufacturing process of micro-structural film, the optical particles (3) adhered to the base material (1) is solidified using a binder (51) and a solidifier (52) of the solidification device (5) and static carried on the roller (2) and the base material (1) adhered with the optical particles (3) is removed using the static remover (6).

Both the binder (51) and the solidifier (52) used in the solidification process may respectively have resin as the binder (51) in conjunction with a heater as the solidifier (52); or alternatively, have an ultraviolet (UV) hardened resin as the binder (51) in conjunction with an ultraviolet (UV) lamp as the solidifier (52) to achieve the same purpose of solidifying the optical particles (3).

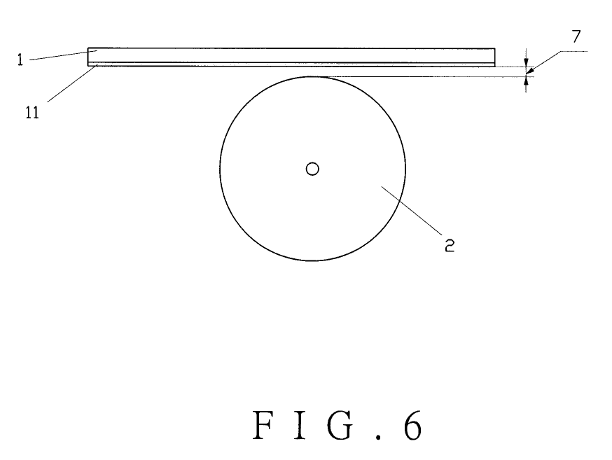

As illustrated in FIG. 6 showing a gap defined between the base material (1) and the roller (2), the adhesion layer (11) of the base material (1) indicates a tangent relation with an outer circumference of the roller (2) without contacting the roller (2); that is, when both the base material (1) and the roller (2) are engaging in relative movement, a given gap (7) is maintained between the adhesion layer (11) of the base material (1) and the roller (2).

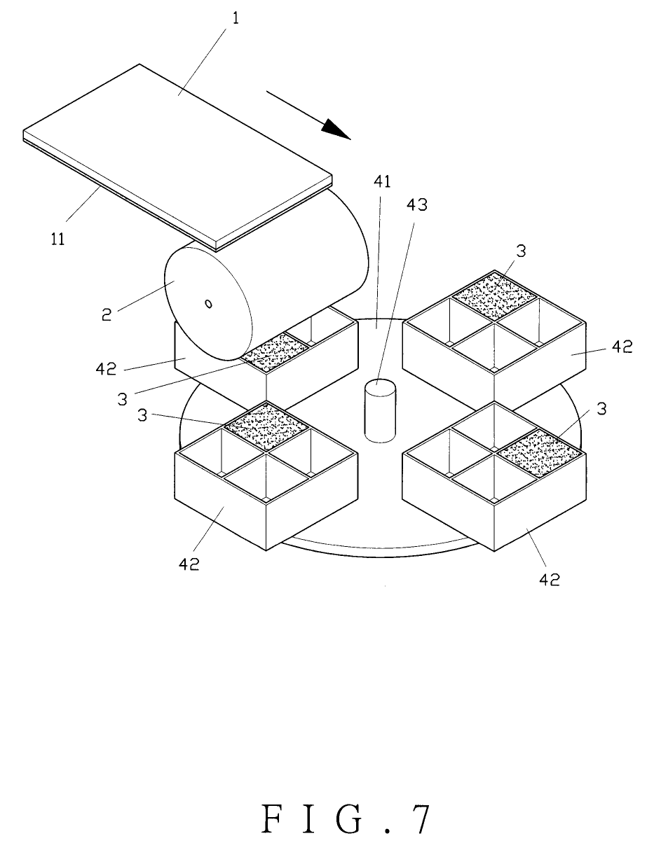

FIG. 7 shows an operating status of a rotary storage tank for optical particles in the preferred embodiment of the present invention; wherein in addition to controlling the roller (2) to produce distribution of static regions, it takes the optical particles (3) in different sizes and shapes to constitute a micro-structural film on the surface of a single base material (1) under different diffusion conditions. To make sure that the optical particles (3) in different sizes and shapes are able to be adhered to the single base material (1), a standing-alone storage tank (42) containing multiple optical particles (3) of different sizes and shapes is mounted on a turn table (41) and is then driven by a revolving axle to rotate for exchange with the standing-alone storage tank (42) containing optical particles (3).

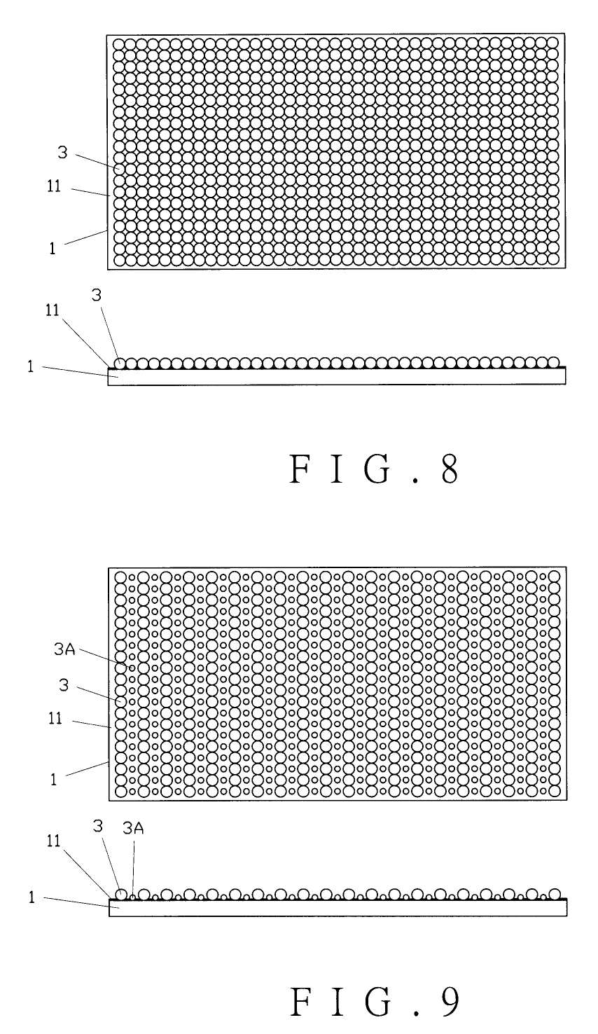

As illustrated in FIG. 8 for a schematic view showing a collective type of micro-structural diffusion film of the preferred embodiment of the present invention, the optical particles (3) constituting the adhesion layer (11) of the base material (1) are of one single size so to effectively upgrade intensity of the particles in arrangement.

In a dispersion type of micro-structural diffusion film of another preferred embodiment of the present invention as illustrated in FIG. 9, the optical particles (3) constituting the adhesion layer (11) of the base material (1) are of various sizes. As illustrated, multiple optical particles (3) and multiple optical particles (3A) of different sizes are capable of effectively upgrading uniformity of the optical particles (3) and (3A) in arrangement.

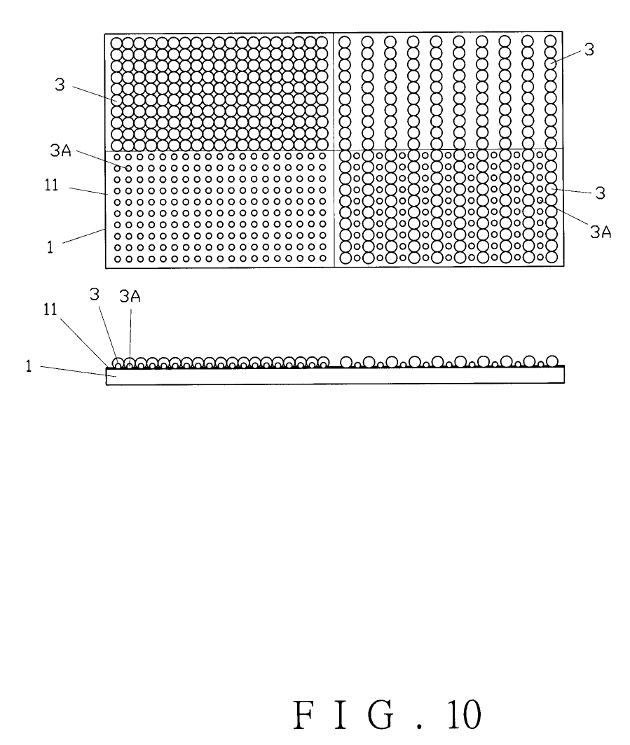

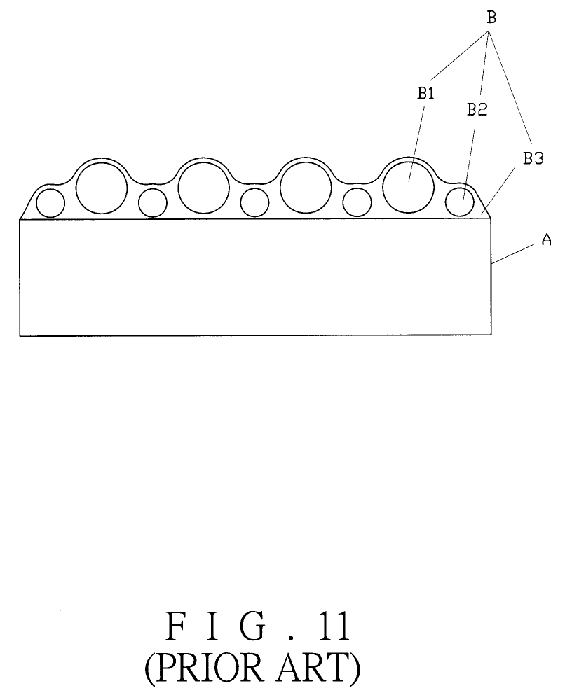

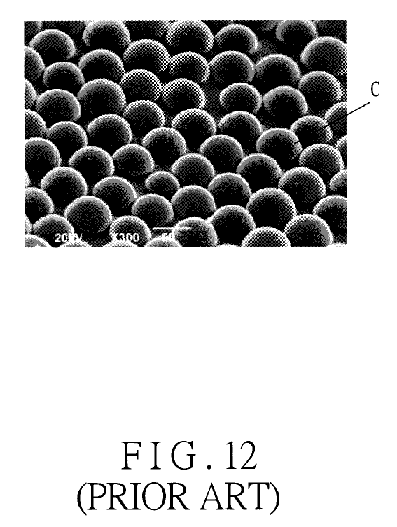

In another preferred embodiment of the present invention as illustrated in FIG. 10 for a mixed type of micro-structural diffusion film, the optical particles (3) and (3A) constituting the adhesion layer (11) of the base material (1) are arranged in collective type and dispersion type depending on the individual region; that is, different diffusion conditions in terms of size of particle, density of distribution, and location are provided to achieve the purpose of controlling extent of diffusion for more uniform performance of lamination by light permeated.

Accordingly, the present invention applies a principle of static absorption in a manufacturing process of micro-structural film by having multiple optical particles adhered to an adhesion layer containing adhesive on a surface of a base material, then solidified and having static removed for the optical particles to form a film of a micro-lens diffusion layer to deliver scattering results when light is permeated for achieving the purpose of uniform luminance; and the present invention allows reduced production cost, and control of surface of base material to develop a micro-structural film under different diffusion conditions to make the present invention an optimal improvement and design in delivering the most feasible improvement of a manufacturing process of micro-structural film.

What is claimed is:

1. A micro-structural film manufacturing process, comprising:
A. coating: an adhesion layer containing adhesive is coated on a surface of a base material;
B. charging: at specific locations of a roller is controlled to indicate a status of carrying negative charges by means of laser or other device;
C. absorption: multiple optical particles carrying positive charges are absorbed to the roller;
D. adhesion: the optical particles carrying positive charges absorbed to the roller are adhered to the adhesion layer on the surface of the base material;
E. solidification: a binder and a solidifier of a solidification device is used to solidify the optical particles adhered to the base material; and
F. removing static: static carried by the roller and by the base material adhered with the optical particles are removed using a static remover.

2. The micro-structural film manufacturing process as claimed in claim 1, wherein the roller maintains in rotation status; the base material indicates a tangent relation with an outer circumference of the roller; and both the base material and the roller engage in relative movements by maintaining a given gap.

3. The micro-structural film manufacturing process as claimed in claim 1, wherein the optical particles are made of transparent or translucent material in any size and shape as desired.

4. The micro-structural film manufacturing process as claimed in claim 1, wherein the solidification step is done by using an adhesive resin in conjunction with a heater to heat up.

5. The micro-structural film manufacturing process as claimed in claim 1, wherein the solidification step is done by using an ultraviolet hardened resin in conjunction with exposure to radiation from an ultraviolet lamp.

6. The micro-structural film manufacturing process as claimed in claim 1, wherein a micro-structural film is developed under different diffusion conditions by having the roller to generate distribution of static regions and application of the optical particles of different sizes and shapes.
